(19) United States
(12) Patent Application Publication
(10) Pub. No.: US 2024/0426652 A1
(43) Pub. Date: Dec. 26, 2024

(54) MICROELECTROMECHANICAL SENSOR ASSEMBLY AND PROCESS FOR MANUFACTURING A MICROELECTROMECHANICAL SENSOR ASSEMBLY

(71) Applicant: STMicroelectronics International N.V., Geneva (CH)

(72) Inventors: Gianluca LONGONI, Cernusco sul Naviglio (IT); Luca SEGHIZZI, Milano (IT); Francesco BIANCHI, Milan (IT); Federico VERCESI, Milano (IT); Andrea NOMELLINI, Milan (IT); Silvia NICOLI, Briosco (IT)

(73) Assignee: STMicroelectronics International N.V., Geneva (CH)

(21) Appl. No.: 18/742,355

(22) Filed: Jun. 13, 2024

(30) Foreign Application Priority Data
Jun. 23, 2023 (IT) 102023000013011

(51) Int. Cl. G01H 11/08; G01P 15/08; H04R 1/08; H04R 7/04; H04R 7/18; H04R 17/02; H04R 31/00

(52) U.S. Cl. CPC G01H 11/08; G01P 15/0802; G01P 2015/0862; H04R 1/08; H04R 7/04; H04R 7/18; H04R 17/02; H04R 31/003; H04R 2201/003

(57) ABSTRACT

A microelectromechanical sensor assembly includes a semiconductor die having a scaled cavity. A microelectromechanical inertial sensor has a sensing mass. A piezoelectric vibration sensor has a piezoelectric membrane. The sensing mass and the piezoelectric membrane are stacked one on top of the other and housed in the sealed cavity.

### PRIORITY CLAIM

This application claims the priority benefit of Italian Application for Patent No. 102023000013011 filed on Jun. 23, 2023, the content of which is hereby incorporated by reference in its entirety to the maximum extent allowable by law.

### TECHNICAL FIELD

The present invention relates to a microelectromechanical sensor assembly and a process for manufacturing a microelectromechanical sensor assembly.

### BACKGROUND

In order to improve the quality of voice communication, especially with the use of True Wireless Stereo (TWS) earphones, it has been proposed to exploit the conduction of sound through the cranial bones, in addition to conventional microphones. Bone conduction of vibrations is not affected in fact by the acoustic noise and by external disturbance that are superimposed on the voice of the speaker and that normally are picked up by microphones. The information that may in this way be obtained enables improvement of identification of the useful spectral content in the voice signals picked up by the microphones and, consequently, noise cancellation. The quality of the voice signal transmitted may thus be improved.

The systems currently available use an inertial device purposely dedicated to detection of the voice via bone conduction, for example an independent accelerometer or accelerometer an integrated in an Inertial Measurement Unit (IMU). Of course, the dedicated inertial device is optimized for the characteristics of the human voice, in particular as regards the bandwidth and the noise level. Further inertial sensors are normally used to implement functions that are increasingly often demanded by the market, such as activity recognition or user-interface functions.

Although the desired functions may effectively be made available, known solutions present limitations above all as regards the freedom of design. An independent inertial sensor imposes constraints on the overall dimensions, this possibly being at the expense of the battery and thus of the autonomy of the devices. Furthermore, the use of a number of independent components usually results in an increase in the production costs. On the other hand, it is problematic for the devices integrated in a same IMU to be optimized for functions that require very different levels of performance, and compromises may be reached that not satisfactory.

Consequently, there is a need in the art to provide a microelectromechanical sensor assembly and a process for manufacturing a microelectromechanical sensor assembly that will enable the limitations described above to be overcome or at least mitigated.

### SUMMARY

Embodiments herein relate to a microelectromechanical sensor assembly and a process for manufacturing a microelectromechanical sensor assembly.

In an embodiment, a microelectromechanical sensor assembly comprises: a semiconductor die having a sealed cavity; a microelectromechanical inertial sensor, having a sensing mass; and a piezoelectric vibration sensor, having a piezoelectric membrane; wherein the sensing mass and the piezoelectric membrane are housed in the sealed cavity.

In an embodiment, a process for manufacturing a microelectromechanical sensor assembly, comprises: forming a semiconductor die having a sealed cavity; forming a microelectromechanical inertial sensor, having a sensing mass; forming a piezoelectric vibration sensor, having a piezoelectric membrane; and housing the sensing mass and the piezoelectric membrane in the sealed cavity.

### BRIEF DESCRIPTION OF THE DRAWINGS

For a better understanding of the present invention, preferred embodiments are described, by way of non-limiting example, with reference to the annexed drawings, wherein:

FIG. 1 is a simplified block diagram of an electronic system comprising a microelectromechanical sensor assembly;

FIG. 2 is a cross-sectional view through a microelectromechanical sensor assembly according to one embodiment, incorporated in the system of FIG. 1;

FIG. 3 is an enlarged top plan view of a first detail of the microelectromechanical device of FIG. 2;

FIG. 4 is an enlarged top plan view of a second detail of the microelectromechanical device of FIG. 2;

FIG. 5 is a cross-sectional view through a microelectromechanical sensor assembly according to a different embodiment;

FIG. 6 is a cross-sectional view through a microelectromechanical sensor assembly according to a further embodiment; and

FIGS. 7-15 are cross-sectional views through a semiconductor wafer in successive machining steps of a process for manufacturing a microelectromechanical sensor assembly.

### DETAILED DESCRIPTION OF THE DRAWINGS

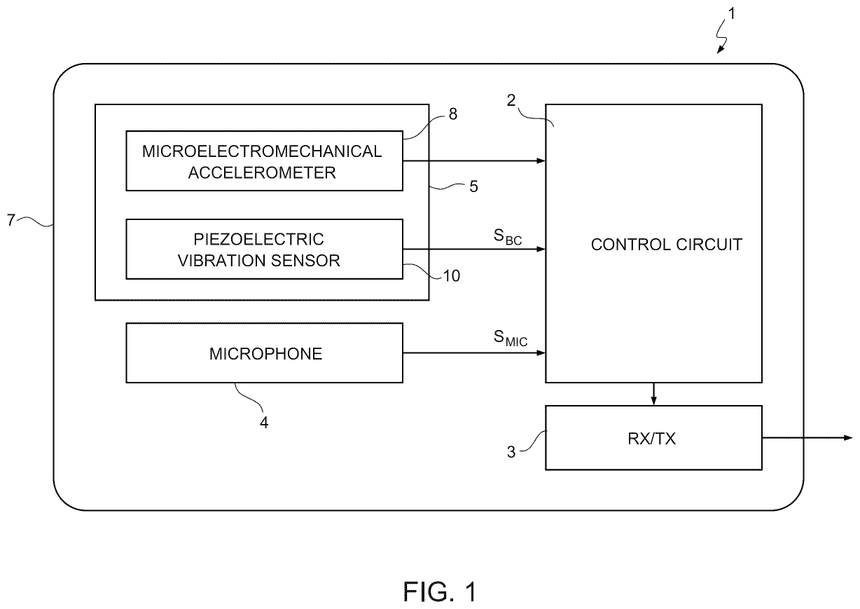

With reference to FIG. 1, a wireless earphone, for example of the True Wireless Stereo (TWS) type, is designated as a whole by reference 1 and comprises a processing (control) circuit 2, a receiver/transmitter stage 3, a microphone 4, and a microelectromechanical sensor assembly 5 according to an embodiment of the present invention. A casing 7 houses the components listed. The earphone 1 may further comprise further components, not illustrated herein for simplicity, amongst which a speaker controlled by the processing circuit 2. The microelectromechanical sensor assembly 5 in turn comprises an inertial sensor, for example a microelectromechanical system (MEMS) accelerometer 8, and a piezoelectric vibration sensor 10, with the function of voice accelerometer. For simplicity, in what follows reference will be made to a uniaxial microelectromechanical accelerometer; it is understood, however, that the inertial sensor may be of any type according to the design preferences, in particular a multiaxial microelectromechanical accelerometer or a uniaxial or multiaxial microelectromechanical gyroscope. In addition, the microelectromechanical sensor assembly 5 may comprise a combination of accelerometers and/or gyroscopes, for example forming an Inertial Measurement Unit (IMU). The piezoelectric vibration sensor 10 is further rigidly coupled to the casing 7 so as to collect the vibrations that propagate from outside to the casing 7.

The processing circuit 2 uses detection signals SBC received from the piezoelectric vibration sensor 10 in order to improve the quality of the audio signal transmitted. The detection signals SBC are generated basically by the voice of the speaker and are without components of environmental noise, being transmitted through the cranial bones. For instance, the processing circuit 2 may use the contents of the detection signals SBC to identify the spectral components of the signal S_{MIC} supplied by the microphone that effectively correspond to the voice, and to filter out the remaining spurious components.

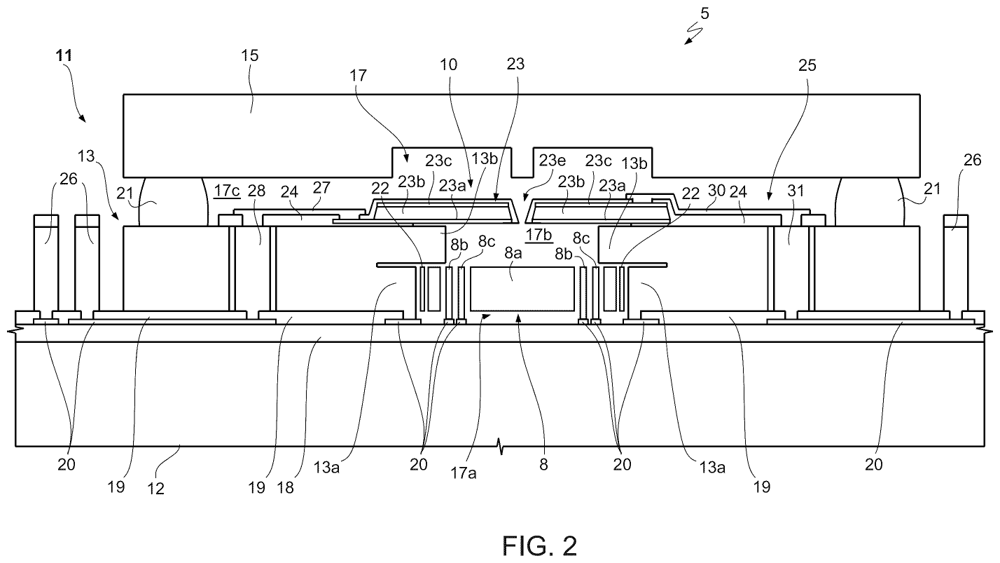

With reference to FIG. 2, the microelectromechanical sensor assembly 5 comprises a semiconductor die 11, in which the accelerometer 8 and the piezoelectric vibration sensor 10 are integrated. The semiconductor die 11 in turn comprises a substrate 12, a supporting body 13, and a cap 15, all including semiconductor material. The substrate 12, the supporting body 13, and the cap 15 are joined together so as to define a sealed cavity 17, in which the microelectromechanical accelerometer 8 and the piezoelectric vibration sensor 10 are housed. The cavity 17 is acoustically isolated from the outside. In the case where the microelectromechanical sensor assembly 5 is equipped with a combination of accelerometers and/or gyroscopes, one or more of these may be included in the cavity 17, whereas other accelerometers and/or gyroscopes may be housed in further cavities, for simplicity not illustrated herein.

The substrate 12 is coated by a separator dielectric layer 18 and by a sacrificial layer 19, for example a silicon-oxide layer, which form an insulating body, where buried conductive paths 20 are embedded.

The supporting body 13 comprises a first portion 13a and a second portion 13b. The first portion 13a is joined to the substrate 12 via the sacrificial layer 19 and the separator layer 18 and laterally delimits a first volume 17a of the cavity 17. The second portion 13b of the supporting body 13 is joined to the first portion 13b on a side opposite to the sacrificial layer 19 and laterally delimits a second volume 17b of the cavity 17, communicating with the first volume 17a. The second portion 13b further functions as support for the piezoelectric vibration sensor 10 and as spacer between the microelectromechanical accelerometer 8 and the piezoelectric vibration sensor 10, which are stacked on top of one another.

The cap 15 is joined to the second portion 13b of the supporting body 13 by bonding structures 21. The cap 15 and the bonding structures 21 delimit a third volume 17c of the cavity 17.

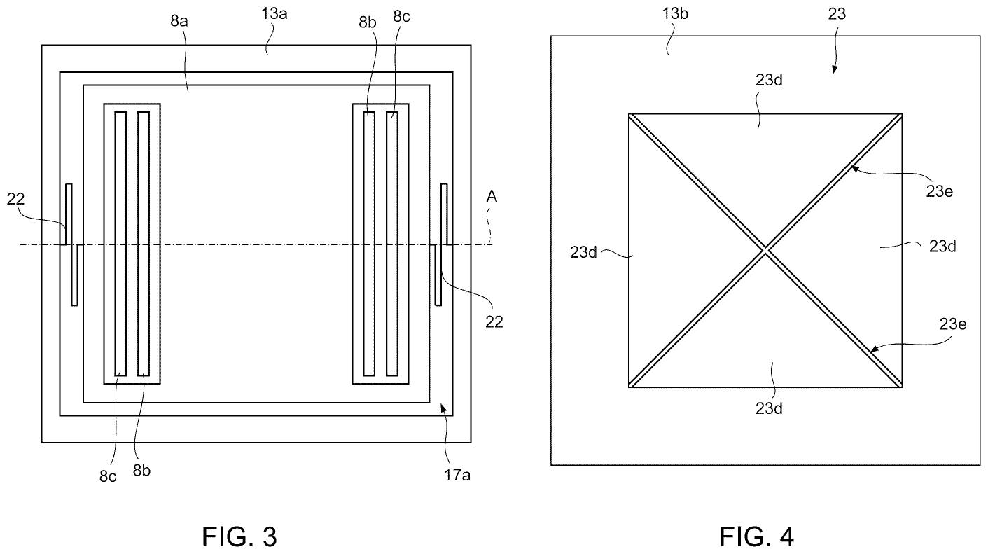

The microelectromechanical accelerometer 8 comprises the sensing mass 8a capacitively coupled in a differential way to fixed electrodes 8b, 8c. See, FIG. 3.

The sensing mass 8a is supported by the first portion 13a of the supporting body 13 in the first volume 17a of the cavity 17. In detail, the sensing mass 8a of the microelectromechanical accelerometer 8 is kept suspended at a distance from the substrate 12 by elastic connections known as flexures 22, configured to enable the sensing mass 8 to oscillate along a sensing axis. The first portion 13a of the supporting body 13 is coupled to a respective one of the buried conductive paths 20 for biasing the sensing mass 8a through the flexures 22. The fixed electrodes 8b, 8c are defined by respective plane semiconductor laminas perpendicular to the sensing axis and fixed to the separator dielectric layer 18 and to the substrate 12 through respective buried conductive paths 20.

The piezoelectric vibration sensor 10 comprises a piezoelectric membrane 23 and a routing structure 25, which are electrically insulated from the supporting body 13 by a dielectric body 24.

The piezoelectric membrane 23 is defined by a multilayer comprising, in order, a first electrode 23a, a piezoelectric lamina 23b, and a second electrode 23c and has a generally polygonal or circular shape. The piezoelectric lamina 23b may, for example, be of aluminum nitride (AlN), lead zirconate titanate (PZT), or sodium-potassium niobate (KNN). The piezoelectric membrane 23 has a peripheral edge anchored to the second portion 13b of the supporting body 13 through the dielectric body 24 and delimits at least partially the second volume 17b of the cavity 17 on a side opposite to the first volume 17a. Furthermore, the piezoelectric membrane 23 separates at least partially the second volume 17b and the third volume 17c of the cavity 17.

In the embodiment of FIGS. 2 and 4, for example, the piezoelectric membrane 23 is quadrangular and comprises four triangular flaps 23d (FIG. 4) that extend in cantilever fashion from the second portion 13b of the supporting body 13 and are separated by through slits 23e. In this case, the piezoelectric membrane 23 is not continuous, and the second volume 17b communicates with the third volume 17c. In other preferred embodiments, the piezoelectric membrane 23 may be continuous, and the second volume 17b and the third volume 17c completely separated from one another.

The routing structure 25 electrically couples the electrodes 23a, 23c of the piezoelectric membrane 23 to respective connectors 26 accessible from outside. In greater detail, the routing structure 25 comprises: a first surface conductive path 27, a first plug 28, and a respective one of the buried conductive paths 20 for connecting the first electrode 23a to the respective connector 26; and a second surface conductive path 30, a second plug 31, and a respective one of the buried conductive paths 20 for connecting the second electrode 23c to the respective connector 26. The plugs 28, 31 extend through the supporting body 13 and connect the first surface conductive path 27 and the second surface conductive path 30 to the respective buried conductive paths 20.

Further connectors 26 (just one of which is illustrated in FIG. 2) enable coupling of the first portion 13a of the supporting body and of the electrodes 8b, 8c of the accelerometer 8 to voltage sources and/or sensing terminals according to the functions of the components.

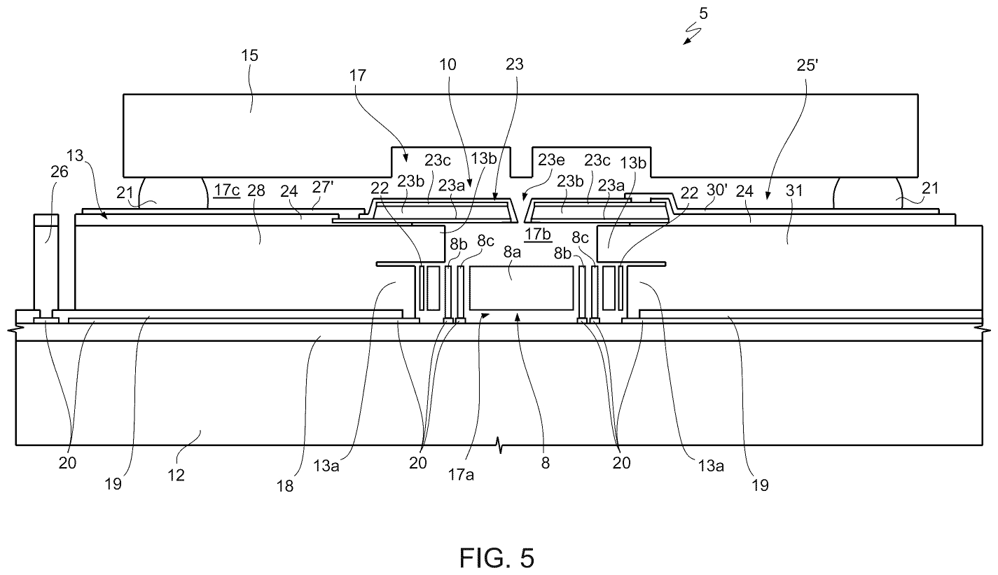

According to a different embodiment, illustrated in FIG. 5, connection between the electrodes 23a, 23c of the piezoelectric membrane 23 and the outside world is obtained through a routing structure 25′ comprising surface conductive paths 27′, 30′ that run over the dielectric body 24 as far as the outside of the bonding structures 21. In this case, the bonding structures 21 are directly in contact with the conductive paths 27′, 30′.

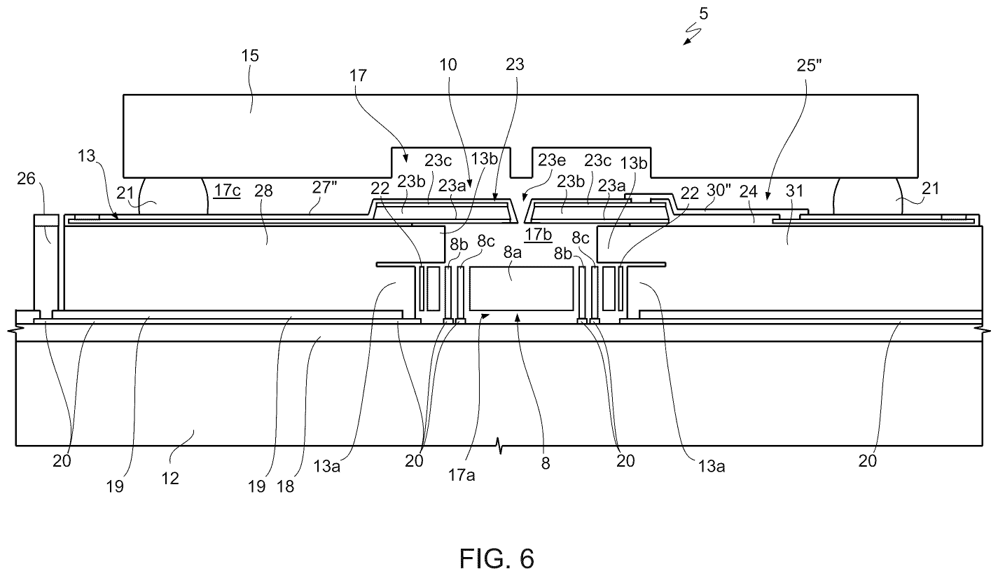

Alternatively, as illustrated in FIG. 6, the routing structure, here designated by 25″, comprises conductive paths 27″, 30″ embedded in the dielectric body 24. The conductive paths 27″, 30″ are obtained from a same conductive layer that forms the first electrode 23a of the piezoelectric membrane 23 and extend as far as the outside of the bonding structure 21, which is in contact with the dielectric body 24. The second electrode 23c is coupled to the conductive path 30″ through a further surface conductive path 32.

The sensor assembly described enables integration of a microelectromechanical inertial sensor and a piezoelectric vibration sensor in a single device. The two sensors may have characteristics very different from one another and thus be optimized separately to perform distinct functions. In particular, the inertial sensor may be used for user-interface functions, such as recognition of commands through movements and/or gestures, whereas the piezoelectric vibration sensor may serve as a voice accelerometer dedicated to voice detection via bone conduction in order to improve the quality of audio communication.

Further, it is possible to integrate other possible functions, according to the design preferences. For instance, the piezoelectric vibration sensor has a sensitivity and speed of response sufficient to implement effectively functions for waking-up the system from conditions of hibernation. Contrary to the inertial sensors, which require an albeit low power supply also in the hibernation state, the piezoelectric vibration sensor is in any case active and may supply signals in response to vibrations even in conditions of practically zero power consumption. Consequently, in the hibernation state, the overall power consumption is negligible, to the benefit of autonomy of the battery-powered devices and in any case in line with the general tendency to privilege energy saving. However, the promptness of response of the piezoelectric vibration sensor enables wake-up from conditions of hibernation in sufficiently short times to prevent any loss of useful data.

The piezoelectric vibration sensor is integrated in the sealed chamber itself of the inertial sensor. Therefore, on the one hand, the piezoelectric vibration sensor is acoustically isolated from outside and is not affected by environmental noise. On the other, the stacked arrangement of the inertial sensor and of the piezoelectric vibration sensor makes it possible to obtain a structure that is compact and far from cumbersome, which is much appreciated especially for the production of miniaturized devices.

Integration affords important advantages also from the standpoint of costs and management of the manufacturing processes. In general, both the production and the purchase of a single component instead of two distinct ones are economically more convenient. Further, the reduction in the number of components is an evident benefit for assembly because the number of operations required is reduced accordingly.

Also, the process for manufacturing of the sensor assemblies is suited to being integrated in manufacturing processes of microelectromechanical devices.

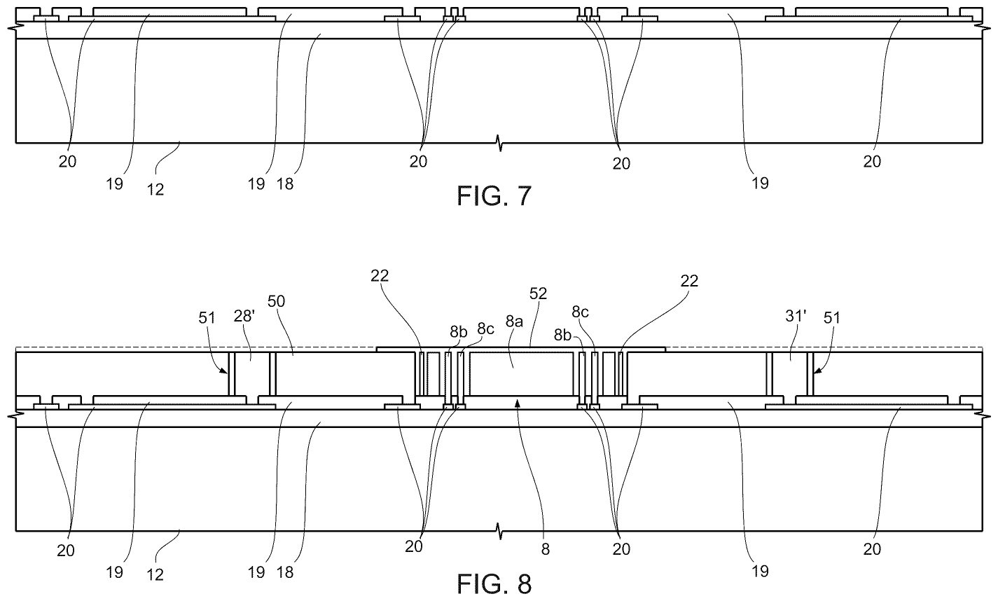

For instance, FIGS. 7-14 represent steps in a process for manufacturing the microelectromechanical sensor assembly 5 of FIG. 2. Initially (FIG. 7), the separator dielectric layer 18 is formed on the substrate 12 of a semiconductor wafer 40, and a layer of polycrystalline silicon is deposited and patterned to form the buried conductive paths 20. Then, the sacrificial layer 19 is deposited and selectively etched to enable subsequent contacting of the buried conductive paths, in particular in positions corresponding to the fixed electrodes 8b, 8c, to the first portion 13a of the supporting body 13, to the plugs 28, 31, and to the connectors 26 of FIG. 2. Further layers, such as a barrier layer to hydrofluoric acid may be optionally formed and selectively removed where not required.

As illustrated in FIG. 8, a first structural layer 50 is then grown, for example by a Chemical-Vapor Deposition (CVD) process of polysilicon in epitaxial reactor. The first structural layer 50 on the sacrificial layer 19 is in contact with the buried conductive paths 20 where the sacrificial layer 19 had previously been removed.

The first structural layer 50 is then planarized by Chemical-Mechanical Polishing (CMP) to a desired thickness, for example comprised between 10 μm and 60 μm.

A trench etch is then carried out to define the sensing mass 8a, the fixed electrodes 8b, 8c, and the flexures 22 in the first structural layer 50. In this step, first insulation trenches 51′ are further opened that delimit bottom portions 28′, 31′ of the plugs 28, 31.

After the trench etch, a first sacrificial layer 52, for example of silicon oxide, is deposited on the first structural layer 50 by Low-Pressure Chemical-Vapor Deposition (LPCVD) of silicon oxide so as to penetrate into the gaps between the sensing mass 8a, the fixed electrodes 8b, 8c, the flexures 22, and the first insulation trenches 51′, filling them partially or completely. The first sacrificial layer 52 is then patterned. In particular, the remaining portion of the first sacrificial layer 52 covers the region where the accelerometer 8 is formed.

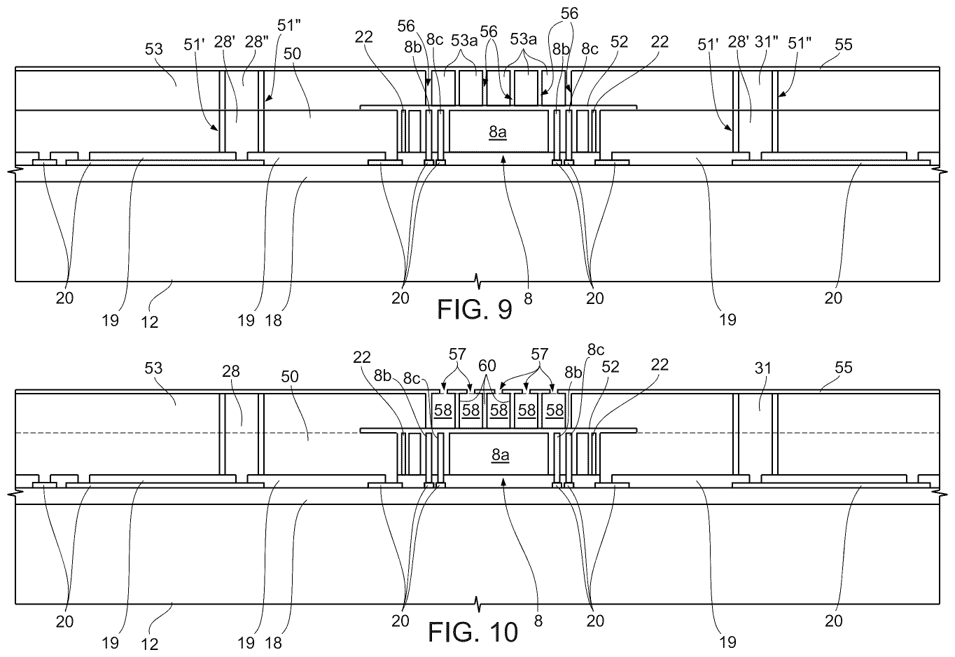

Next (FIG. 9), a second structural layer 53 is grown on the first structural layer 50 and then planarized. The first sacrificial layer 52 separates the second structural layer 53 from the portions of the first structural layer 50 in which the sensing mass 8a, the fixed electrodes 8b, 8c, and the flexures 22 have been provided.

The second structural layer 53 is then selectively etched with a second trench etch that stops on the first sacrificial layer 52. In the second structural layer 53 islands 53a are thus formed separated by trenches 56 and second insulation trenches 51″ are opened aligned to respective first insulation trenches 51′ that delimit top portions 28″, 31″ of the plugs 28, 31. The etched portion of the second structural layer 53 corresponds to the second volume 17b of the cavity 17 of FIG. 2 and defines the second portion 13b of the supporting body 13.

A second sacrificial layer 55 is then formed on the second structural layer 53 so as to fill the trenches 56 completely between the islands 53a.

Next (FIG. 10), openings 57 are formed in the second sacrificial layer 55 on the islands 53a. The islands 53a are then etched in an isotropic way through the openings 57 and removed, while the remaining part of the second structural layer 53 is protected by the second sacrificial layer 55. At the end of the etch, instead of the islands 53a cavities 58 are present, delimited at the top by the second sacrificial layer 55, which extends continuously except for the openings 57. The cavities 58 are further separated from one another by diaphragms 60 formed by portions of the second sacrificial layer 55 that had previously penetrated between the islands 53a. As a whole, the cavities 58 substantially correspond to the second volume 17b of the cavity 17 of FIG. 2.

As illustrated in FIG. 11, a capping layer 61, for example of silicon oxide or silicon nitride, is deposited on the second sacrificial layer 55 by PECVD (Plasma-Enhanced Chemical-Vapor Deposition), coating it completely and closing the openings 57 and the access to the cavities 58. The capping layer 61 and the second sacrificial layer 55 are selectively etched to open contact windows 62 in positions corresponding to respective connectors 26. The diaphragms 60 and the capping layer 61 form a sacrificial supporting structure that closes the second volume 17b of the cavity 17 and will be used to form the membrane 23.

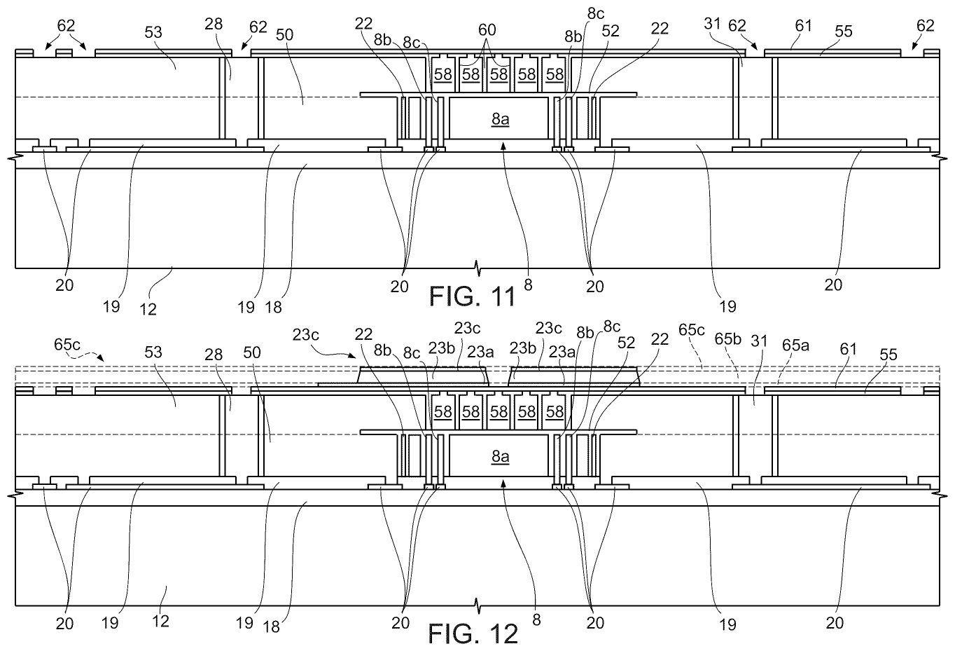

A piezoelectric multilayer 65 is then deposited (FIG. 12), which is patterned to form the piezoelectric membrane 23. In greater detail, the piezoelectric multilayer 65 comprises a first electrode layer 65a (for example, molybdenum, platinum, aluminum), a piezoelectric layer 65b (for example, aluminum nitride, or PZT), and a second electrode layer 65c (for example, molybdenum, platinum, aluminum), which are patterned to form respectively the first electrode 23a, the piezoelectric lamina 23b, and the second electrode 23c of the piezoelectric membrane 23.

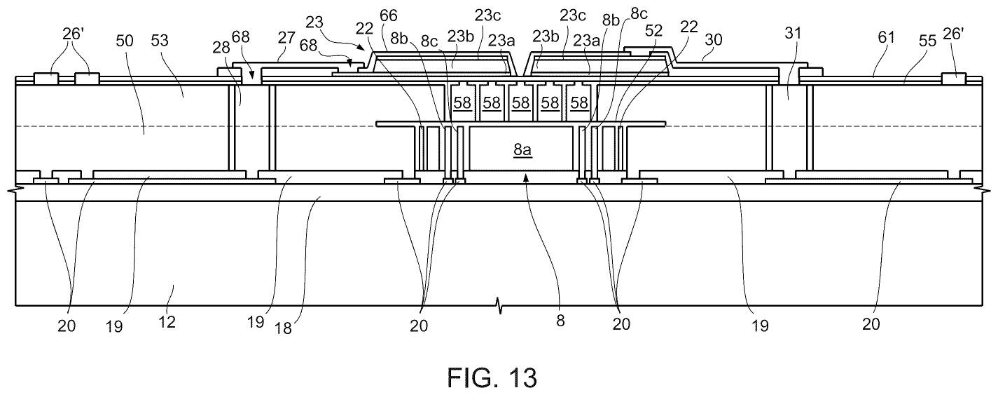

Then (FIG. 13), a passivation layer 66 is deposited and patterned. In detail, the passivation layer 66 is removed outside the region occupied by the piezoelectric membrane 23 and by the conductive paths 27, 30 that will have to be formed thereafter. Furthermore, on the first electrode 23a, on the second electrode 23c, and in areas corresponding to the plugs 28, 31 contact windows 68 are opened. A metal layer (not illustrated) is deposited and defined to form the conductive paths 27, 30 and metal portions 26′ of the connectors 26.

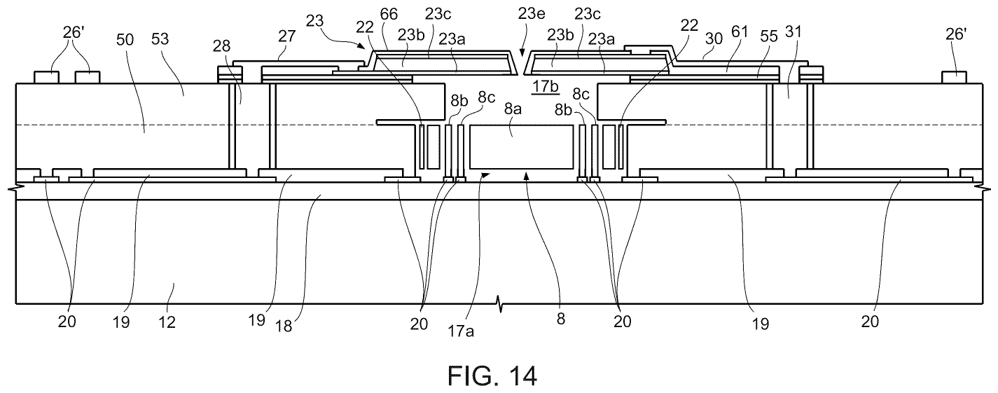

Next, an etch is performed, for example using hydrofluoric acid to remove the sacrificial parts where exposed. In this step, the sacrificial layer 55 is removed both on the second structural layer 53 and under the piezoelectric membrane 23, through the through slits 23e. In particular, the walls 60 between the cavities 58 are eliminated, and the cavities 58 are joined in the second volume 17b of the cavity 17 of FIG. 2. Residual portions of the second sacrificial layer 55 of the capping layer 61 and of the passivation layer 66 form the dielectric body 24. As illustrated in FIG. 14, there are further removed also the first sacrificial layer 51 and portions of the sacrificial layer 19 that may be reached after etching of the first sacrificial layer 51. In this way, the movable mass 8a of the accelerometer 8 is released.

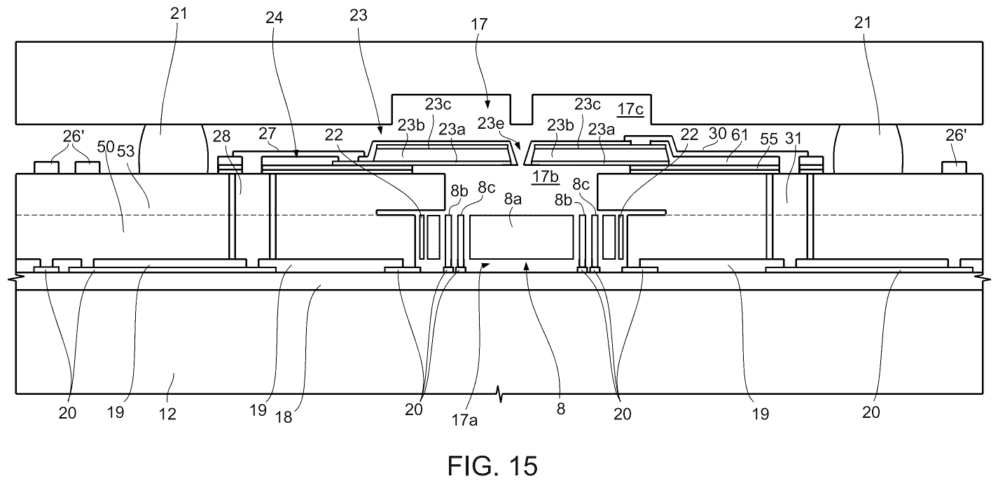

Next, a cap wafer 70 is joined to the wafer 40 (FIG. 15) via the bonding structures 21 in controlled pressure conditions, thus sealing the cavity 17.

Finally, the cap wafer 70, the second structural layer 53, and the first structural layer 50 are etched to define the supporting body 13 and the connectors 26, and the wafer 40 is diced, thus obtaining the structure of FIG. 2.

Finally, it is clear that modifications and variations may be made to the sensor assembly and to the process described herein, without thereby departing from the scope of the present invention, as defined in the annexed claims.

For instance, the inertial sensor integrated in the microelectromechanical sensor assembly may comprise one or more uniaxial or multiaxial accelerometers, one or more uniaxial or multiaxial gyroscopes, or a combination thereof.

The shape of the piezoelectric membrane may conveniently be chosen on the basis of the design preferences.

1. A microelectromechanical sensor assembly, comprising:
a semiconductor die having a sealed cavity;
a microelectromechanical inertial sensor having a sensing mass; and
a piezoelectric vibration sensor having a piezoelectric membrane;
wherein the sensing mass and the piezoelectric membrane are housed in the sealed cavity.

2. The sensor assembly according to claim 1, wherein the microelectromechanical inertial sensor and the piezoelectric vibration sensor are stacked on top of one another in the sealed cavity.

3. The sensor assembly according to claim 1, wherein the semiconductor die comprises a substrate, a supporting body, and a cap joined together, and wherein the sealed cavity is defined between the substrate, the supporting body, and the cap.

4. The sensor assembly according to claim 3, wherein the sensing mass of the microelectromechanical inertial sensor is arranged between the substrate and the piezoelectric membrane of the piezoelectric vibration sensor.

5. The sensor assembly according to claim 4, wherein the microelectromechanical inertial sensor and the piezoelectric vibration sensor are supported by the supporting body, and the piezoelectric membrane is coupled to the supporting body so that vibrations propagating in the supporting body are transmitted to the piezoelectric vibration sensor.

6. The sensor assembly according to claim 5, wherein the supporting body comprises a first portion, said first portion joined to the substrate and laterally delimiting a first volume of the cavity, and wherein the inertial sensor comprises a sensing mass elastically supported by the first portion of the supporting body in the first volume of the cavity so as to be able to oscillate along a sensing axis.

7. The sensor assembly according to claim 6, wherein the supporting body comprises a second portion, joined to the first portion on a side opposite to the substrate and laterally delimiting a second volume of the cavity, the second volume being in communication with the first volume, and wherein the piezoelectric membrane is anchored to the second portion of the supporting body and delimits at least partially the second volume of the cavity on a side opposite to the first volume.

8. The sensor assembly according to claim 7, wherein the cap is joined to the second portion of the supporting body by bonding structures, wherein the cap and the bonding structures delimit a third volume of the cavity.

9. The sensor assembly according to claim 8, wherein the piezoelectric membrane separates at least partially the second volume and the third volume of the cavity.

10. The sensor assembly according to claim 8, wherein the piezoelectric membrane has through slits and wherein the second volume and the third volume of the cavity are in communication with each other by way of said through slits.

11. The sensor assembly according to claim 7, wherein the second portion of the supporting body defines a spacer element between the microelectromechanical inertial sensor and the piezoelectric vibration sensor.

12. A process for manufacturing a microelectromechanical sensor assembly, comprising:
forming a semiconductor die having a sealed cavity;
forming a microelectromechanical inertial sensor having a sensing mass;
forming a piezoelectric vibration sensor having a piezoelectric membrane; and
housing the sensing mass and the piezoelectric membrane in the sealed cavity.

13. The process according to claim 12, wherein housing comprises stacking the microelectromechanical inertial sensor and the piezoelectric vibration sensor on top of one another in the sealed cavity.

14. The manufacturing process according to claim 12, wherein forming the microelectromechanical inertial sensor comprises:
forming a first structural layer on a substrate containing semiconductor material; and
defining the sensing mass in the first structural layer in a region corresponding to a first volume of the cavity;
wherein defining the sensing mass comprises forming flexures between the movable mass and a remaining portion of the first structural layer and electrodes fixed to the substrate and capacitively coupled to the movable mass.

15. The process according to claim 14, wherein forming the piezoelectric vibration sensor comprises:
forming a second structural layer on the first structural layer;
etching the second structural layer in a region corresponding to a second volume of the cavity, the second volume being in communication with the first volume;
forming a sacrificial supporting structure in the second volume;
forming the piezoelectric membrane on the sacrificial supporting structure; and
releasing the second volume underneath the piezoelectric membrane.
